(19) United States
(12) Patent Application Publication
(10) Pub. No.: US 2004/0153345 A1
(43) Pub. Date: Aug. 5, 2004

(54) System and method for processing records associated with a healthcare encounter

(76) Inventor: Mary Archuleta Heckle, Layton, UT (US)

Correspondence Address: Alexander J. Burke, Intellectual Property Department, 5th Floor, 170 Wood Avenue South, Iselin, NJ, 08830, US

(21) Appl. No.: 10/734,400

(22) Filed: Dec. 12, 2003

Related U.S. Application Data
(60) Provisional application No. 60/444,829, filed on Feb. 4, 2003.

(51) Int. Cl. G06F 17/60

(52) U.S. Cl. 705/3

(57) ABSTRACT

Certain exemplary embodiments provide a system for processing records associated with a patient encounter with a healthcare organization. The system comprises a document processor for receiving a document representing a record associated with a patient encounter with a healthcare organization and for appending identifiers to said received document, said identifiers including: an encounter identifier identifying a particular healthcare encounter of a particular patient, a medical record identifier identifying a patient medical record of said particular patient, and a patient record section identifier identifying a particular section of said patient medical record; and an output processor for processing said document, including said appended identifiers, for output.

### CROSS-REFERENCE TO RELATED APPLICATIONS

This application claims priority to pending provisional application Serial No. 60/444,829, filed 4 Feb. 2003.

### BACKGROUND

Existing medical information processing involves a significant burden in processing paper (and electronic) records associated with patient encounters with a healthcare system. The burden arises from the need to sort and file loose sheet records and electronic records. It is necessary to file reports into the patient's healthcare record in a timely manner so that the information is readily available for patient care and other business processes. This task is typically compounded by the absence of identifiers (e.g. a medical record number) or the non-standard format of identifiers used in sorting records. Identifiers are absent from records for a variety of reasons. A paper record may have become partially damaged in processing or partially illegible or a record may be missing an identifier or have an incorrect identifier or conflicting identifiers, perhaps resulting from incorrect data entry. The problem grows with the size of the healthcare facility. A system according to invention principles addresses these and derivative problems.

### SUMMARY

Certain exemplary embodiments provide a system for processing records associated with a patient encounter with a healthcare organization. The system comprises a document processor for receiving a document representing a record associated with a patient encounter with a healthcare organization and for appending identifiers to said received document, said identifiers including: an encounter identifier identifying a particular healthcare encounter of a particular patient, a medical record identifier identifying a patient medical record of said particular patient, and a patient record section identifier identifying a particular section of said patient medical record; and an output processor for processing said document, including said appended identifiers, for output.

### BRIEF DESCRIPTION OF THE DRAWINGS

A wide array of potential embodiments can be better understood through the following detailed description and the accompanying drawings in which:

FIG. 1 is a block diagram of an exemplary embodiment of a system 1000;

FIG. 2 is a block diagram of an exemplary embodiment of an information device 2000;

FIG. 3 is a flow chart of an exemplary embodiment of a method 3000;

FIG. 4 is a diagram of exemplary embodiment of a user interface 4000; and

FIG. 5 is a diagram of exemplary embodiment of a machine 5000.

### DEFINITIONS

When the following terms are used herein, the accompanying definitions apply:

patient encounter—a patient and healthcare organization interaction that has a financial or transaction consequence. A patient encounter can include any of several types of events, for example, a patient visit, phone call, inpatient stay, outpatient treatment, interview, examination, procedure, treatment-related occurrence, admission to a healthcare organization, test, order for medication, discharge, and/or a user-defined event based on acquired information, etc. A patient encounter can be bounded by a start and/or end time (and/or date), which can be determined by time and/or date of the event, for example, a time and/or date of patient admission and/or discharge from a healthcare organization.

document—a physical and/or electronic collection of related data elements. If physical, a document comprises one or more sheets of paper and the related data elements printed thereon. A document can be and/or represent a record of a patient encounter with a healthcare organization.

identifier—a group of symbols that are unique to a particular entity, activity, and/or document. An identifier can be, for example, a medical record identifier. An identifier can be human and/or machine readable, such as for example, a number, an alphanumeric string, a bar code, an RFID, etc.

patient identifier—an identifier for a particular patient of a healthcare organization. A patient identifier might be a social security number, taxpayer ID number, national ID number, Medicare number, Medicaid number, medical insurance ID number, etc.

encounter identifier—an identifier for a particular patient encounter of a particular patient.

medical record identifier—an identifier for a patient medical record of a particular patient.

patient record section identifier—an identifier for a particular section of a particular patient medical record (record sections include, for example, face sheet, X-ray report, pathology report, discharge summary report, operative report, laboratory result reports, history and physical report). For example, a laboratory results section may have patient record section identifier (an “index number identifier”) of 10 and a discharge summary section may have an index identifier number 5.

user identifier—an identifier for a particular user of a device and/or system described herein.

processor—a device and/or set of machine-readable instructions for performing a task. A processor comprises any one or combination of hardware, firmware, and/or software. A processor acts upon information by manipulating, analyzing, modifying, converting, transmitting the information for use by an executable procedure and/or an information device, and/or routing the information to an output device. A processor may use the capabilities of a controller.

collator—a device for sorting physical documents.

audit trail—a detailed record of activities performed, including the time and/or date performed, and the entity (e.g., person, organization, and/or device, etc.) initiating, authorizing, and/or performing the activity. An audit trail can log the creation, filing, access, editing, modification, printing, copying, and/or scanning of a document.

### DETAILED DESCRIPTION

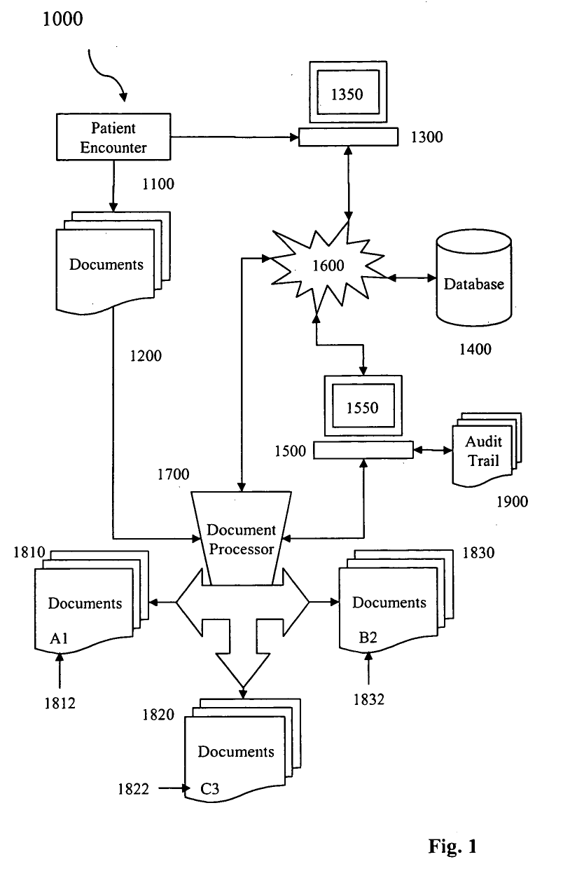

FIG. 1 is a block diagram of an exemplary embodiment of a system 1000, in which a patient experiences a patient encounter 1100 with a healthcare organization. Documents 1200, which represent a record associated with patient encounter 1100, are received by a document processor 1700, which can provide any of numerous functions. For example, upon receipt of a document, document processor 1700 can examine the document and determine what identifiers are present and what identifiers are missing, damaged, erroneous, conflicting, etc. Numerous identifiers are possible, such as for example, an encounter identifier, medical record identifier, patient identifier, patient record section identifier, and/or user identifier, etc. If desired, document processor 1700 appends one or more identifiers to the document. If desired, document processor 1700 collates documents into any number of desired subsets 1810, 1820, 1830. For example, document processor 1700 can sort various laboratory test reports by, for example, medical record identifier, to facilitate physical and/or electronic filing of those test reports. Encounter identifier 1812 is shown on document subset 1810. Medical record identifier 1822 is shown on document subset 1820. Patient record section identifier 1832 is shown on document subset 1830. If desired, document processor 1700 stores documents for later retrieval.

Related to patient encounter 1100 can be data that is entered, via a user interface 1350, into an information device 1300, which can be coupled by a network 1600 to a database 1400, one or more other information devices 1500, and/or document processor 1700.

Information device 1300, information device 1500, and/or document processor 1700 can provide any of numerous functions, including for example, examining a document; determining one or more identifiers that are present, missing, incorrect, conflicting, and/or illegible, etc.; assigning one or more identifiers to the document; appending one or more identifiers to the document; sorting the document; storing the document; retrieving the document; receiving a user identification; copying, scanning, and/or printing the document; and/or generating an audit trail (e.g., input audit trail, copying audit trail, scanning audit trail, printing audit trail, and/or all activities audit trail, etc.), etc.

In certain embodiments, system 1000 assigns and/or appends identifiers to electronic records (e.g., prior to or during scanning of a corresponding paper record into an electronic document) and paper records (e.g., prior to and/or during a sorting operation). In certain embodiments, the identifiers facilitate sorting and filing of medical records. System 1000 appends the identifiers with symbols comprised by and/or making up the identifiers and/or may encode bar code labels and/or other codes representing the identifiers. On a paper copy this may be effectuated by laser printing or any other imprinting, stamping, and/or labeling mechanism. In an electronic record, the identifiers are added in a consistent standardized electronic format. In certain embodiments, however, system 1000 supports adapting the format to the needs of a particular customer.

In certain embodiments, after one or more identifiers have been identified and/or appended to a document, the system 1000 can track the location of that document. System 1000 can track the location of the document even within document processor 1700, on an information device 1300 and/or 1500, and/or in a database 1400. System 1000 can retrieve the document on demand. Thus, for example, assume that once a physical document has entered document processor 1700 for sorting and is in the process of being sorted, a user requests the document. Upon receiving the request, document processor 1700 locates the document, removes it from the sorting process, and provides it to an output tray for retrieval by the requesting user.

Document processor 1700 comprises a copier for providing physical copies of provided paper documents, a scanner for obtaining an electronic document version of a paper document, and a printer for printing a paper copy of a document and/or record including the identifiers. In certain embodiments, the copier, scanner, and/or printer are provided as separate devices that are coupled to document processor 1700. System 1000 automatically scans and stores an electronic version of a document being sorted and appends the three identifiers to the electronic document as well as imprinting them on the paper version. System 1000 further includes a HIPAA audit compliant copier for detecting and identifying those copying documents and the documents being copied.

In certain embodiments, system 1000 further supports sorting of electronic or paper records appended with the three identifiers into a desired order adaptively selectable by a user. For example, a user is able to designate collation of records by any combination of the three identifiers or by only one or two of the identifiers. Thereby a user is able to collate records for a particular patient encounter, a particular patient medical record or by a particular section of a particular medical record (e.g. laboratory test results) of a particular patient, for example.

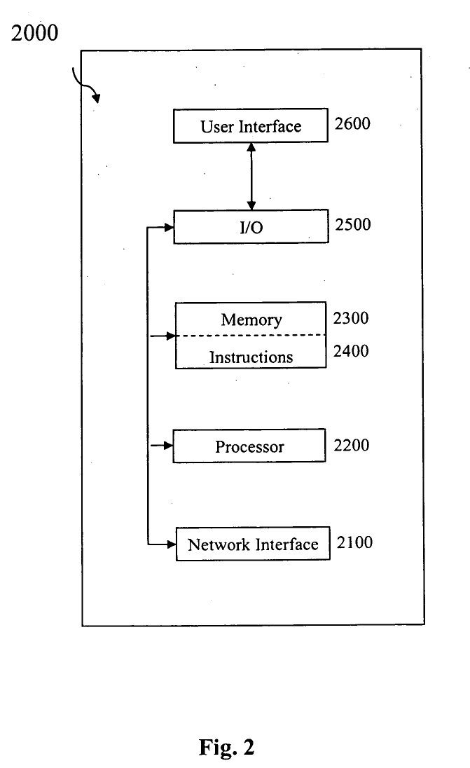

FIG. 2 is a block diagram of an exemplary embodiment of an information device 2000, which can represent any of information device 1300, 1500, and/or document processor 1700 of FIG. 1. Information device 2000 includes any of numerous well-known components, such as for example, one or more network interfaces 2100, one or more processors 2200, one or more memories 2300 containing instructions 2400, and/or one or more input/output (I/O) devices 2500, etc. Via one or more I/O devices 2500, a user interface 2600 can be provided.

As used herein, the term “information device” means any device capable of processing information, such as any general purpose and/or special purpose computer, such as a personal computer, workstation, server, minicomputer, mainframe, supercomputer, computer terminal, laptop, wearable computer.

As used herein, the term “network interface” means any device, system, or subsystem capable of coupling an information device to a network. For example, a network interface can be a telephone, cellular phone, cellular modem, telephone data modem, fax modem, wireless transceiver, ethernet card, cable modem, digital subscriber line interface, bridge, hub, router, or other similar device.

As used herein, a “memory device” means any hardware element capable of data storage, such as for example, a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc.

In certain exemplary embodiments, via one or more user interfaces 2600, data and/or records regarding one or more documents are created, input, identified, searched, requested, provided, received, retrieved, revised, and/or deleted. In certain exemplary embodiments, via one or more user interfaces 2600, one or more audit trails are created, input, identified, searched, requested, provided, received, retrieved, revised, and/or deleted. In certain exemplary embodiments, a processor, running on and/or via an information device 2000, provides any or all of these functions.

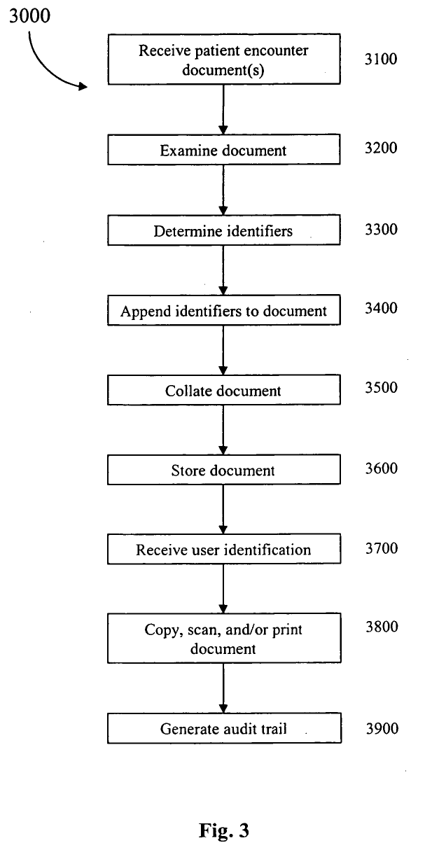

FIG. 3 is a flow chart of an exemplary embodiment of a method 3000. At activity 3100, one or more patient encounter documents are received, potentially at a document processor. At activity 3200, a document is examined. At activity 3300, identifiers that are present, missing, incorrect, conflicting, and/or illegible, etc. are determined. At activity 3400, missing, correct, substitute, legible, and/or additional identifiers are appended to the document. At activity 3500, documents are sorted according to one or more predetermined identifiers. At activity 3600, documents are stored physically and/or electronically. At activity 3700, a user identification is received. At activity 3800, a document is accessed, viewed, modified, copied, printed, and/or scanned, etc. At activity 3900, an audit trail is generated that identifies the document and one or more activities and/or categories of activities performed on the document (e.g., accessed, viewed, modified, copied, printed, and/or scanned, etc.).

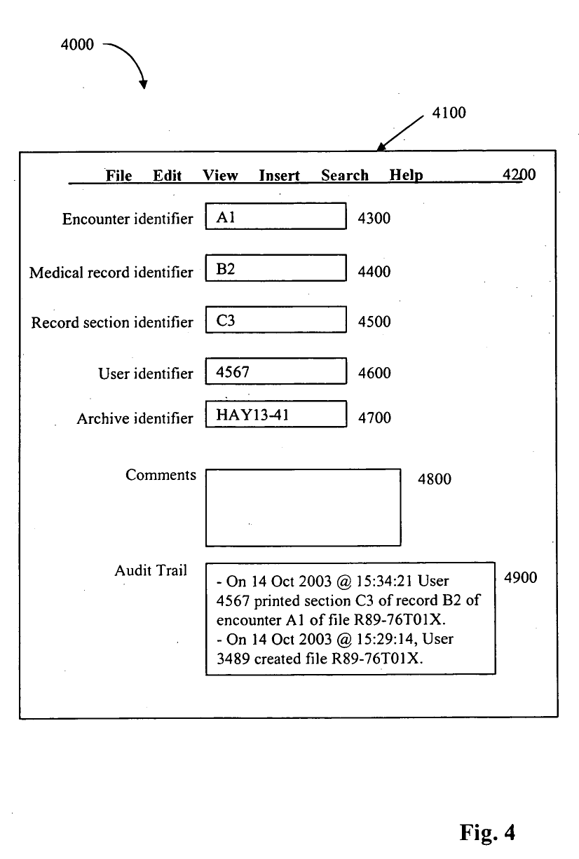

FIG. 4 is a diagram of exemplary embodiment of a user interface 4000, which comprises a plurality of user interface elements 4100. If desired, user interface 4000 includes one or more menus 4200 for initiating appropriate actions, such as accessing, displaying, searching within, modifying, annotating; analyzing, appending identifiers to, copying, scanning, printing, and/or storing, etc., a document; searching a database of documents; reviewing an audit trail; setting and/or responding to alarms and/or notifications; importing and/or exporting information to a document database; and/or generating reports; etc. Any of an encounter identifier field 4300, medical record identifier field 4400, record section identifier field 4500, user identifier field 4600, archive identifier field 4700, comments field 4800, and/or audit trail field 4900 are provided for entry, searching, display, and/or reporting.

An automated exemplary number based sorting process for reducing manual sorting time is described below.

Factors that can affect the sorting process include: size of the facility; number of beds; number of visits per year for, I=Inpatient, O=Outpatient, E=Emergency; number of reports handled, daily, weekly, monthly, yearly (number of inches of documents received per day); number of employees responsible for the filing process; number of hours to sort the loose sheets; number of minutes to locate a hard copy report for an on-demand request; type of filing system and storage used (e.g., centralized (same area=Medical Records Department) or decentralized (outside of the Medical Records Department, e.g. clinics)); terminal digit or straight numeric or other; type of manual sorter used (e.g., metal divider 00-99, or flat cardex A-Z or 00-99, etc.); medical record number is either printed or written on the form and/or a barcoded label; types of reports desired (e.g., computer generated History &Physical, Operative, Discharge Summary, Lab Results single and/or summary form); type of hard copy loose sheet (e.g. standard size paper (full sheet), single, two-sided, or half sheet), etc.

In certain exemplary embodiments, a machine automatically sorts documents according to identification number. Prior to implementing the automated sorting process, the documents enter a sorting feeder of the machine one sheet at a time. Either the machine or an operator may determine if a given sheet has an imprinted identification number that can be read by the machine's numeric reader. If the determination is “Yes”, the hard copy has an identification number, and the sheet directly enters the feeder and passes through to the numeric reader/sorter. If the determination is “No”, the user enters the identification number using the machine's ten digit keypad. The sheet enters the feeder and the machine imprints the identification number on the sheet before it enters the numeric reader/sorter.

The following steps are comprised by an exemplary embodiment of an automated sorting process that utilizes a terminal digit numbering system, that is, a numbering system of the form TT-SS-PP, wherein TT are two tertiary digits, T1 and T2, SS are two secondary digits, S1 and S2, and PP are two primary digits, P1 and P2, respectively. Exemplary terminal digit numbers include 10-25-00, 10-25-01, 10-26-01, and 10-26-02, wherein the primary digits are 00's, the secondary digit are 20's, and the tertiary digits 10's.

To implement the automated sorting process, an automated sorting machine having a plurality of sorting sections, each having a plurality of trays, can be used. For example, for the automated sorting of documents numbered according to a numbering system of the form TT-SS-PP, the automated sorting machine can have 6 sorting sections, identified according to the digits sorted (e.g., T1, T2, S1, S2, P1, P2), each having 10 trays to correspond to the possible variations in that digit (e.g., 0 through 9). The sorting process can proceed from primary digits to secondary digits to tertiary digits, or vice versa.

For example, the machine can begin the sorting process by sorting the documents by tertiary digits T1 and routing the sorted documents into one of 10 trays in section T1. Then, the machine can remove all the documents in tray 0 of section T1 and sort them according to digit T2 and place them into the 10 trays of section T2. Then, the machine can remove all the documents in tray 0 of section T2 and sort them according to digit S1 and route them into the 10 trays of section S1. This process can continue until sorting according to digit P2 is completed. Then the documents can be removed from the trays of section P2, starting with tray 0, and stored face down in a storage section. At this point, all documents having an identification number of the form 00-00-0P will be stored in the storage section in correct ascending numerical order.

Next, the machine can remove all the documents in tray 1 of section P1, sort them according to digit P2, place them into the 10 trays of section P2, and then remove them (starting with tray 0), and stored them face down in the storage section, behind the documents already there. At this point, all documents having an identification number of the form 00-00-1P will be stored in the storage section in correct ascending numerical order, behind those of the form 00-00-0P.

This process can continue through all the sections until all documents in the machine's sections and trays have been sorted by terminal digit number and placed in sorted ascending order in the stack of the storage section. Sheets in the storage section can be removed at any time for filing or further handling, if desired.

Note that this process can be facilitated by using trays that decrease in size according to the digits sorted (e.g., T1, T2, S1, S2, P1, P2), with the trays for T1 being the largest, since they will hold the most documents at any one time. Note also that this process can work in a reverse fashion in which documents are sorted by P2 first, with the sorting process proceeding toward tertiary digit T1. Processes and/or machines following these general principals can be implemented for identifiers that contain a different number of digits and/or contain non-numeric characters, etc. Likewise, processes and/or machines following these general principals can be implemented for multiple identifiers.

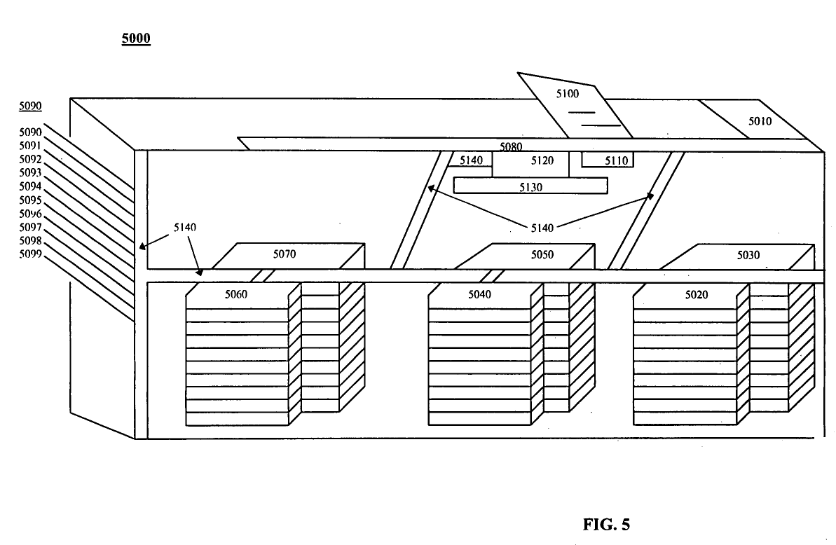

FIG. 5 is a diagram of exemplary embodiment of a machine 5000, which can be used for identifying and/or sorting loose sheets. Machine 5000 is just one possible implementation or many possible hardware and/or software implementations for identifying and/or sorting loose sheets. As shown, a 10 key pad 5010, which can be used for entering document identifiers, is disposed on an upper surface of machine 5000, along with a message display panel 5080. Also shown disposed on an upper surface of machine 5000 is a automatic loose sheet feeder 5100. A sheet flows from sheet feeder 5100 to a numeric imprinter 5110, which imprints and/or encodes an identifier on the sheet. The imprinted sheet then flows past an identifier reader/router device 5120, which reads the imprinted identifier and establishes a routing for the sheet. Sensor/gripper roller mechanism 5130, which travels on tracks 5140, transports and/or routes sheets to and/or between multi-tray bins 5020, 5030, 5040, 5050, 5060, 5070, and/or external tray set 5090, which comprises trays 5091-5099.

Still other embodiments will become readily apparent to those skilled in this art from reading the above-recited detailed description and drawings of certain exemplary embodiments.

What is claimed is:

1. A system for processing records associated with a patient encounter with a healthcare organization, comprising:
a document processor for receiving a document representing a record associated with a patient encounter with a healthcare organization and for appending identifiers to said received document, said identifiers including:
(a) an encounter identifier identifying a particular healthcare encounter of a particular patient,
(b) a medical record identifier identifying a patient medical record of said particular patient, and
(c) a patient record section identifier identifying a particular section of said patient medical record; and
an output processor for processing said document, including said appended identifiers, for output.

2. A system according to claim 1, wherein
said received document is an electronic document comprising data representing said record associated with said patient encounter with a healthcare organization and
said document processor appends data representing said identifiers to said received document.

3. A system according to claim 1, wherein
said received document is a paper document comprising data representing said record associated with said patient encounter with a healthcare organization and
said document processor appends said identifiers to said received document by imprinting said identifiers onto said document.

4. A system according to claim 3, wherein
said document processor appends said identifiers to said received document by imprinting on said document at least one of: (a) characters comprising said identifiers, (b) a bar code representing said identifiers and (c) other codes representing said identifiers.

5. A system according to claim 1, wherein
said document processor appends said identifiers to said received document in response to user selection and entry of data representing said identifiers.

6. A system according to claim 1, wherein
said document processor appends said identifiers to said received document in response to an event occurring in a healthcare organization including at least one of: (a) a patient admission, (b) a beginning of a medical procedure, (c) an end of a medical procedure, (d) a patient discharge, and (e) a user-defined event based on acquired information.

7. A system according to claim 1, including
an identification processor for parsing and examining said received document to determine information for use in deriving said identifiers.

8. A system according to claim 1, including
said document processor automatically appends said identifiers to said received document in response to identification of said received document.

9. A system for sorting records associated with patient encounters with a healthcare organization, comprising:
a document processor for receiving documents representing records associated with patient encounters with a healthcare organization; and
a collator for sorting said received documents based on identifiers appended to said received documents to provide sorted documents, said identifiers including,
(a) an encounter identifier identifying a particular healthcare encounter of a particular patient,
(b) a medical record identifier identifying a patient medical record of said particular patient, and
(c) a patient record section identifier identifying a particular section of said patient medical record.

10. A system according to claim 1, wherein
said collator sorts and groups records based on said identifiers.

11. A system according to claim 1, wherein
said collator sorts and groups records in response to user selection of a prioritized order of said identifiers.

12. A system according to claim 1, wherein
said collator sorts and groups records in response to user selection of a combination of one or more of said identifiers.

13. A system for processing records associated with a patient encounter with a healthcare organization, comprising:
a document processor for receiving a document representing a record associated with a patient encounter with a healthcare organization and for appending identifiers to said received document, said identifiers including,
(a) an encounter identifier identifying a particular healthcare encounter of a particular patient,
(b) a medical record identifier identifying a patient medical record of said particular patient, and
(c) a patient record section identifier identifying a particular section of said patient medical record; and
a collator for sorting documents based on said appended identifiers to provide sorted documents.

14. A system according to claim 13, wherein
said collator sorts and groups records in response to user selection of a combination of one or more of said identifiers.

15. A system according to claim 13, further comprising a copy processor for:
receiving user identification information in authorizing document copying, and
scanning and storing said identifiers in maintaining a record of users and copied documents for use in maintaining a copying audit trail.

16. A system for securely copying records associated with a patient encounter with a healthcare organization, comprising:
an interface processor for receiving user identification information;
a document processor for receiving a document including identifiers comprising,
(a) an encounter identifier identifying a particular healthcare encounter of a particular patient,
(b) a medical record identifier identifying a patient medical record of said particular patient, and
(c) a patient record section identifier identifying a particular section of said patient medical record; and
a copy processor for initiating copying of said document in response to said user identification information and for scanning and storing said identifiers in maintaining a record of users and copied documents for use in maintaining a copying audit trail.

17. A system according to claim 16, wherein:
said copy processor comprises a printing processor for initiating printing of said document in response to said user identification information and for scanning and storing said identifiers in maintaining a record of users and printed documents for use in maintaining a printing audit trail.

18. A system according to claim 16, wherein:
said copy processor comprises a scanning processor for initiating scanning of said document in response to said user identification information and for scanning and storing said identifiers in maintaining a record of users and scanned documents for use in maintaining a scanning audit trail.

19. A machine-readable medium containing instructions for activities comprising:
receiving a document representing a record associated with a patient encounter with a healthcare organization;
appending identifiers to said received document, said identifiers including:
(a) an encounter identifier identifying a particular healthcare encounter of a particular patient,
(b) a medical record identifier identifying a patient medical record of said particular patient, and
(c) a patient record section identifier identifying a particular section of said patient medical record; and
processing said document, including said appended identifiers, for output.
